(19) United States
(12) Patent Application Publication
(10) Pub. No.: US 2025/0115497 A1
(43) Pub. Date: Apr. 10, 2025

(54) SULFATE REMOVAL FROM WATER

(71) Applicant: CHEMTREAT, INC., Glen Allen, VA (US)

(72) Inventors: Vladimir DJUKANOVIC, Glen Allen, VA (US); Naresh N. MAHAMUNI, Henrico, VA (US)

(73) Assignee: CHEMTREAT, INC., Glen Allen, VA (US)

(21) Appl. No.: 18/906,894

(22) Filed: Oct. 4, 2024

Related U.S. Application Data
(60) Provisional application No. 63/542,882, filed on Oct. 6, 2023.

(51) Int. Cl. C02F 1/52; C02F 1/66; C02F 101/10; C02F 101/12; C02F 101/16; C02F 101/20

(52) U.S. Cl. CPC C02F 1/5245; C02F 1/66; C02F 2101/101; C02F 2101/103; C02F 2101/12; C02F 2101/163; C02F 2101/203

(57) ABSTRACT

A method for treating water to remove sulfate from the water, when the sulfate is present in the water in an amount of at least 500 ppm, the method including combining a calcium precipitant and an aluminum precipitant together with the water, reacting the calcium precipitant and the aluminum precipitant with the sulfate in the water to form sulfate precipitates, and removing the sulfate precipitates from the water to provide purified water.

### CROSS-REFERENCE TO RELATED APPLICATIONS

This application claims the earlier filing date benefit of U.S. Provisional Application No. 63/542,882, filed on Oct. 6, 2023, the entirety of which is incorporated by reference herein.

### BACKGROUND

Sulfate is often found in water, such as drinking water. However, sulfate may be toxic, corrosive, and contribute to bad taste and malodors. For example, concentrations of sulfate higher than about 500 mg/l may result in corrosion of conduits, and concentrations above 600 mg/l may result in laxative effects in persons drinking the water. In addition, sulfate can be toxic towards wild plants and wild life.

The general standard for sulfate in drinking or run off water is typically 500 mg/l. Sulfate also has a secondary regulatory standard of 250 mg/l for drinking water. However, the standards for sulfate concentrations in water may vary by locality. For example, in Minnesota, sulfate discharges are limited to as low as 10 mg/l to protect wild rice habitat.

Sulfate removal is necessary to meet regulatory limits and to recycle or reuse water in water conservation efforts. Sulfate is typically removed by methods such as chemical treatment, membrane filtration, ion exchange, distillation/evaporation, adsorption, and/or biological sulfate removal. Of these, chemical treatment typically offers lower capital costs.

A given chemical treatment product is typically only effective to form precipitates at a predetermined concentration of sulfate in the water. Accordingly, administering a chemical treatment product to water with a concentration of sulfate outside of the corresponding range associated with the treatment product often results in inefficient or even no removal of the sulfate in the water. Thus, an appropriate treatment product must be selected based on a concentration of sulfate in the water.

Often a first chemical treatment product is applied at a first stage of treatment of the water. After a predetermined amount of time or after a predetermined amount of sulfate has been removed, the first chemical treatment product is not able to remove sulfate from the water to lower levels. Accordingly, after the first stage, any sulfate precipitants are removed from the water in a solid/liquid separation device, and the water is passed to a second stage in which a second chemical treatment product (which includes a different chemical than the first treatment product) is applied to further reduce the concentration of sulfate. This process may be repeated until the concentration of sulfate in the water reaches a target range.

This multi-stage treatment process is considered to be a necessary arrangement because the first treatment product (e.g., a first precipitant) interferes with or reacts with the second treatment product (e.g., a second precipitant) such that the two products cannot be used together. The multi-stage setup results in additional time for completion of each stage and additional equipment and efforts for administering each stage. For example, multiple calculations for determining a treatment amount for each treatment product at each stage and the corresponding time of reaction for each stage must be determined. Further, additional measurements and calculations may be required for each treatment applied or each treatment stage, leaving room for error.

### SUMMARY

In one aspect, this disclosure provides a method and treatment product for removing sulfate from water that reduces or eliminates these drawbacks.

In one aspect, this disclosure provides a method for treating water to remove sulfate from the water, wherein the sulfate is present in the water in an amount of at least 500 ppm, the method comprising combining a calcium precipitant and an aluminum precipitant together with the water, reacting the calcium precipitant and the aluminum precipitant with the sulfate in the water to form sulfate precipitates, and removing the sulfate precipitates from the water to provide purified water.

In another aspect, the disclosure provides a single-stage reaction method for treating water containing sulfate, the method comprising combining a calcium precipitant and an aluminum precipitant together with the water in the same vessel, reacting the precipitants with the sulfate in the water to form sulfate precipitates, and separating the sulfate precipitates from the water to provide purified water that has an amount of sulfate that is less than 500 mg/l.

In another aspect, the disclosure provides a combined treatment product that is effective to form precipitates with sulfate in water, the combined treatment product comprising a blend that includes a calcium precipitant, and an aluminum precipitant, wherein a molar ratio of calcium in the combined treatment product to aluminum in the combined treatment product is in a range of 1:1 to 12:1.

### BRIEF DESCRIPTION OF THE DRAWINGS

FIG. 1 is a flow chart depicting a single stage process according to an embodiment of the present disclosure;

FIG. 2 is a graph depicting sulfate removal from water containing sulfate by treating the water with treatment products according to an embodiment of the present disclosure;

FIG. 3 is a graph depicting sulfate removal from water containing sulfate by treating the water with treatment products according to an embodiment of the present disclosure;

FIG. 4 is a graph depicting sulfate removal from water containing sulfate by treating the water with treatment products according to an embodiment of the present disclosure;

FIG. 5 is a graph depicting sulfate removal from water containing sulfate by treating the water with treatment products according to an embodiment of the present disclosure;

FIG. 6 is a graph depicting sulfate removal from water containing sulfate by treating the water with treatment products according to an embodiment of the present disclosure;

FIG. 7 is a graph depicting sulfate removal from water containing sulfate by treating the water with treatment products according to an embodiment of the present disclosure;

FIG. 8 is a graph depicting sulfate removal from water containing sulfate by treating the water with treatment products according to an embodiment of the present disclosure; and

FIG. 9 is a graph depicting sulfate removal from water containing sulfate by treating the water with treatment products according to an embodiment of the present disclosure.

### DETAILED DESCRIPTION OF EMBODIMENTS

In the following description, numerous details are set forth to provide an understanding of the present disclosure. However, it may be understood by those skilled in the art that the methods and systems of the present disclosure may be practiced without these details and that numerous variations or modifications from the described embodiments may be possible.

The water that is treated in accordance with this disclosure may include any aqueous stream or body that is more than 75 wt. % water, and generally more than 95 wt. % water. For example, the water may include municipal water, industry process water, industry cooling water, storm water, agriculture runoff and return flows, wastewater, and/or rainwater.

In embodiments, the chemical treatment of water forms precipitates with the sulfate in the water. For example, chemical treatment products include precipitants that react with sulfate and produce gypsum, barite, and ettringite precipitates. The precipitates are then physically removed from the water, thereby effectively removing sulfate from the solution. The method and/or device for removing the precipitate(s) is not particularly limited and may include, for example, a clarifier, a filter, a centrifuge, or a settling tank.

As discussed above, precipitant treatments are conventionally administered in series in multiple stages and/or with multiple treatment products to effectively lower the sulfate concentration.

Disclosed herein are chemical treatment products, methods, and systems for treating water containing sulfates to provide a purified water. The disclosed embodiments may treat the water in a single stage or with a combined treatment product that includes more than one precipitant. By adding the combined treatment product to the water at a predetermined molar ratio, only a single dosage of the treatment product may be required to effectively remove sulfate from the water. In some embodiments, the single dosage may be applied only once at a beginning of the treatment process. Further, only a single stage of treatment may be required to effectively remove sulfate from the water. Thus multiple product administering steps and/or multiple reaction stages are not required. Accordingly, the above described complexities from administering multiple products and effectuating multiple product stages are eliminated.

In addition, deficiencies in the prior art are overcome because the precipitants can be selected and added in relative amounts such that they do not interfere with each other when combined together in the water. Surprisingly, the combination of precipitants of this disclosure improves the kinetics of the precipitation reactions such that the overall removal of sulfate from the water proceeds at a faster rate. This reduces the overall time of the process.

### Chemical Treatment

The chemical treatment may include a calcium precipitant and an aluminum precipitant added together with the water.

The calcium precipitant may be a lime or a non-lime precipitant. The lime precipitant includes quicklime (CaO) or slaked lime (Ca(OH)₂). The non-lime calcium precipitant may include, for example, calcium chloride or Ca(OH)₂. Lime is the most common calcium precipitant that is used to remove sulfate from water. In embodiments of this disclosure, non-lime precipitant compounds may be preferred when used in a single-stage system with an aluminum precipitant because the non-lime precipitant may interfere less with the aluminum precipitant. Calcium precipitates may also include but are not limited to calcium acetate, calcium hydrosulfide, calcium hypochlorite, calcium nitrate, calcium chlorate, calcium cyanide, calcium gluconate, calcium ascorbate, calcium bromide, or a combination thereof.

The calcium precipitant will react with sulfate in the water at the right pH conditions to form a calcium sulfate precipitate, such as gypsum. Gypsum may be formed by the following reaction:

Ca²⁺+SO₄²⁻+2H₂O→CaSO₄·2H₂O

The aluminum precipitant may include but is not limited to, for example, an aluminate, aluminum chloride, aluminum hydroxide, aluminum oxide, aluminum trihydroxe, aluminum metal, aluminum hydro phosphate, aluminum chlorohydrate, aluminum trihydrate, hydrated aluminum sulfate, aluminum nitrate, potassium aluminum, or a combination thereof.

The aluminum precipitant will also react with sulfate in the water at the right pH conditions to from an aluminum sulfate precipitate, such as ettringite. The ettringite may be formed by the following reaction:

6CaO+Al₂(SO₄)3.8H₂O+H₂O→Ca₆Al₂(SO₄)₃(OH)₁₂·26H₂O

When the treatment product includes both calcium precipitant and aluminum precipitant, the precipitate formed may be a compound including Ca, Al, and SO₄. Whereas if the calcium precipitant and the aluminum precipitant are added separately, or in different stages, the precipitants formed may be CaSO₄ and AlSO₄. Advantageously, the solubility of the compound containing Ca, Al, and SO₄ may be very low as compared to either CaSO₄ or AlSO₄. Thus, a final concentration of sulfate in the water may also be lower. For example, if a sufficient amount of the treatment product is added to water, a final concentration of sulfate in the water achieved may be less than 5 mg/L.

As shown in the above formulas, calcium is utilized in the formation of the gypsum as well as ettringite. Accordingly in embodiments, the water is treated with a stoichiometric amount of calcium that is greater than a stoichiometric amount of aluminum, and a combined treatment product can be formulated with calcium and aluminum precipitants in the appropriate stoichiometric ratio. Similarly, the stoichiometric amount of calcium precipitant that is added to the water can be greater than a stoichiometric amount of sulfate in the water.

The treatment can include adding calcium to the water and aluminum to the water in a molar ratio (calcium:aluminum) that is in the range of from 1:1 to 12:1; 2:1 to 8:1; or 3:1 to 5.5:1. Likewise, any combined treatment product can include the respective precipitants in relative amounts corresponding to the ratios described herein. As used herein, molar ratios are based on the moles of the elemental (or ionic) component, i.e., Ca, Al, or Ba. Molar ratios of sulfate are based on the moles of SO₄²⁻.

The amount of calcium and aluminum, and optionally other precipitants, added to the water during the treatment can be based on a measured amount of sulfate or an expected amount of sulfate in the water. In general, the molar ratio of calcium to sulfate can be in the range of from 1:1 to 12:1; 2:1 to 8:1; or 3:1 to 5.5:1.

In general, the molar ratio of aluminum to sulfate can be in the range of from 1:8 to 8:1; 1:4 to 4:1; or 1:2 to 2:1.

For example, in some embodiments, the calcium, the aluminum, and the sulfate in the water are combined at a ratio of about 4.5:1:1, respectively.

In some embodiments, the calcium and the aluminum precipitants may be a premixed as a solid blend, a liquid blend, or a slurry.

In some embodiments, the calcium precipitant and the aluminum precipitant can be separately combined with the water, i.e., added separately but present in the water together. For example, the calcium precipitant and the aluminum precipitant may be added to the water simultaneously, during overlapping periods, or one after the other.

The solid blend may be a dry blend, such as a dry powder. The solid blend may achieve 100% or near 100% reactivity (i.e., reactions resulting in sulfate precipitate) since the solid blend does not include water.

The liquid blend may be more soluble in the water in comparison to the solid blend. Accordingly, where the liquid blend is used, the reaction time might be decreased as additional time is not needed to dissolve the blend into the water. The precipitants in the blends, such as in the liquid blend, can be chosen so that each has a solubility in water (at 20° C. and neutral pH) of at least 10 g/L, 100 g/L, at least 200 g/L, such as from about 250 g/L to 750 g/L, for example. Examples include CaCl₂ as the calcium precipitant and AlCl₃ as the aluminum precipitant. The liquid blend may also be easier to mix with or add to the water. The liquid blend can include from 40 to 95 wt. % water, or from 65 to 90 wt. % water, for example.

In the slurry, some or all of the precipitant particles can be suspended in a liquid. The slurry may provide a combination of advantages of the liquid blend and the solid blend.

In some embodiments, the pH of the water can be set to a predetermined range to facilitate the formation of precipitates of gypsum and ettringite. For example, the reaction of the aluminum precipitant forming the ettringite can limit the effective pH range due to the solubility of the aluminum precipitant. The water can be maintained at a pH in the range of from 9-14, 11-13, or 11.5-12.5.

A control mechanism can be used to control a pH of the water. The control mechanism may be, for example, a system that measures the pH and adds a pH adjusting agent to the water until the water reaches the desired or a predetermined pH. The pH adjusting agent may be included with the treatment product or as part of the treatment product. The control mechanism may dose the water with a pH adjusting agent such as a base, for example, sodium hydroxide, sodium carbonate, sodium bicarbonate, magnesium hydroxide, magnesium bicarbonate, or a combination thereof. The pH adjusting agent is separate from the precipitants. But in some embodiments, lime can be added to increase the pH of the water while simultaneously acting as the calcium precipitant. In some embodiments, the treatment product and the base may be added to the water simultaneously, or separately, such as in immediate succession of one another.

The treatment product including the calcium precipitant and the aluminum precipitant may be applied to water with a concentration of sulfate of up to 1,000 ppm, 2,000 ppm, 5,000 ppm, or 10,000 ppm. The water may have a concentration of sulfate in the range of as low as 10 ppm, 50 ppm, 100 ppm, 200 ppm, or 500 ppm.

In some embodiments, the treatment method may further include combining a barium precipitant with the water to be treated together with the calcium and aluminum precipitants. In case a combined treatment product is used that includes a blend of precipitants, the barium precipitant may be combined with both of the calcium precipitant and the aluminum precipitant. Alternatively, the barium precipitant may be combined with only one of the calcium precipitant and the aluminum precipitant. The barium precipitant may include but is not limited to, for example, barite ore, barium hydroxide, barium carbonate, barium chloride, barium sulfide, barium oxide, barium nitrate, barium acetate, barium hydroxide, barium bromide, barium perchlorate, barium nitrite, barium iodide, or a combination thereof.

The barium precipitant may react with sulfate in the water to form a barium sulfate precipitate, such as barite. The barite may be formed by the following reaction:

Ba²⁺(aq)+SO₄²⁻(aq)→BaSO₄

The treatment can include adding calcium and barium to the water in a molar ratio (calcium:barium) in the range of 1:1 to 10:1; 1.5:1 to 6:1; or 2:1 to 3:1.

The molar ratio of barium to the aluminum (barium:aluminum) can be in the range of 0.3:1 to 10:1; 0.5:1 to 5:1; or 1:1 to 2:1.

The molar ratio of barium to sulfate in the water can be in the range of 0.3:1 to 10:1; 0.5:1 to 5:1; or 1:1 to 2:1.

Barium precipitates to form barite faster than the gypsum reaction. Accordingly, when a barium precipitant is used in combination with a calcium precipitant in accordance with the treatment methods described herein, the barium will react with the sulfate first, which can reserve a sufficient amount of the calcium precipitant to remain available in forming ettringite. For this reason, the use of barium is particularly effective when added to water with a relatively high concentration of sulfate, such as above 2,000 ppm, because the barium precipitant will react first and lower the sulfate to levels that are favorably removed by the gypsum and ettringite reactions.

For example, with the addition of the barium precipitant, the treatment range of concentrations for the water may not be limited. In some embodiments, a treatment product including the barium precipitant may be applied to water with a concentration of sulfate in the range of from 1,800 ppm to 10,000 ppm, from 2,000 ppm to 5,000 ppm, or from 2,500 ppm to 4,000 ppm, for example.

The inclusion of barium can effectively speed up the kinetics of the sulfate precipitation reactions. In this regard, and by way of illustration, in a conventional two stage treatment process that uses lime in a first stage and an aluminum precipitant in the second stage, each stage may take 60 minutes for the precipitation reactions to complete, or a total of 120 minutes. If barium is used in a single stage treatment reaction with appropriate calcium and/or aluminum precipitants, the same degree of sulfate removal can be achieved in perhaps 30 minutes in a single stage.

In addition, the use of barium precipitant is advantageous because the formation of barite may not have significant pH dependence. For example, barium precipitant may be added to water simultaneously with a pH adjusting agent. When the treatment including the barium precipitant and the pH adjusting agent is added to the water with a pH below 10, 11, or 11.5, the barium precipitant may react with the sulfate, lowering the sulfate concentration while the pH is outside of a range for effective reaction of the calcium precipitant or the aluminum precipitant. Simultaneously, the pH of the water may rise by addition of the pH adjusting agent. Accordingly, the sulfate concentration may be lowered by the barium precipitant while the pH rises to an appropriate range for the reaction of calcium and/or aluminum. Thus, the step of changing the pH of the water may simultaneously occur with the formation of the barium precipitate, reducing the time of the overall reaction.

Accordingly, a treatment method or a combined treatment product including barium precipitant offers various advantages such as effective treatment of sulfate across a larger range of sulfate concentrations, simultaneous removal of sulfate from the water while changing a pH of the water, and a fast reaction rate which reduces the overall reaction time for the treatment product to remove sulfate from the water.

In some embodiments, the treatment method may further include adding a cationic surfactant to the water to be treated. The cationic surfactant may be a quaternary ammonium salt, for example. The cationic surfactant may be at least one of cetyltrimethylammonium bromide (CTAB), benzalkonium chloride (BAC), dodecylbenzene sulfonic acid, trimethylalkylammonium chlorides, and alkyldimethylbenzylammonium chloride (ADBAC).

The cationic surfactant can improve the efficiency of sulfate removal from the water because it can be entrapped in the ettringite precipitate. For example, ettringite is a hydrous calcium aluminum sulfate mineral with both anionic and cationic functionalities. Many cationic surfactants have a positively charged head group. This positively charged head group can interact with the negatively charged sites on ettringite, which enables the cationic surfactant to be incorporated into the structure of the ettringite, effectively functionalizing the ettringite with the cationic surfactant. The addition of the cationic surfactant to the ettringite can enable the ettringite to capture a larger amount of sulfate by adsorption, for example, by attracting the sulfates anions to the ettringite.

In some embodiments, the pH of the water can be set to a predetermined range to facilitate removal of the sulfate when the cationic surfactant is used. For example, the efficacy of the removal of sulfate by this adsorption mechanism may be dependent on a pH of the water, and the removal of sulfate may be more effective at an acidic pH. Accordingly, the water can be maintained at a pH in the range of from 1-8, 2-7.5, 3-7, or 4-6.5. The pH of the water may be adjusted, for example, by the above described control mechanism. The control mechanism may dose the water with a pH adjusting agent such as an acid.

In some embodiments, the efficacy of the adsorption may be dependent upon a charge of the precipitate. For example, a precipitate, such as ettringite, may carry a surface charge. As that charge approaches zero or goes below zero, the adsorption of the sulfate onto the ettringite functionalized by the cationic surfactant may increase. The surface charge of the precipitate may be controlled by, for example, adjusting a pH of the water.

The cationic surfactant may be added to the water in a dosage in a range of 25 ppm to 2,500 ppm; 50 ppm to 1,500 ppm; 100 ppm to 1000 ppm; or 300 ppm to 700 ppm.

In some embodiments, the cationic surfactant may be added to the water separately from any of the calcium precipitant, aluminum precipitant, or barium precipitant. In some embodiments, the cationic surfactant may be added to the water together with any of the calcium precipitant, aluminum precipitant, or barium precipitant.

In some embodiments, the cationic surfactant may be added after formation of the ettringite. For example, the precipitants may be added to the water to be treated and the ettringite may be formed. A pH of the water may then optionally be adjusted, for example, to an acidic region. The cationic surfactant may then be added to the water. In some embodiments, the pH of the water may be lowered into an acidic region during formation of the precipitates by the natural chemistries of the precipitation, and the cationic surfactant may be added during or after formation of the precipitants, with or without the pH of the water being adjusted, for example, by the control mechanism. In some embodiments, the pH may be adjusted after addition of the cationic surfactant.

In some embodiments, the cationic surfactant may improve the percentage of sulfate removal in the water and/or reduce the amount of time to reduce the sulfate in the water. For example, the cationic surfactant may improve the amount of sulfate removed from the water in comparison with a treatment including the calcium and aluminum precipitants alone, by an amount in a range of from 1-90%, 5-75%, 10-50%, or 15-30%. The single stage process with a treatment including the cationic surfactant and the calcium and aluminum precipitants may also take 1-90%, 10-80%, 20-70%, 30-60%, or 40-50% less time in comparison with a treatment including the calcium and aluminum precipitants alone.

### Single-Stage Reaction Process

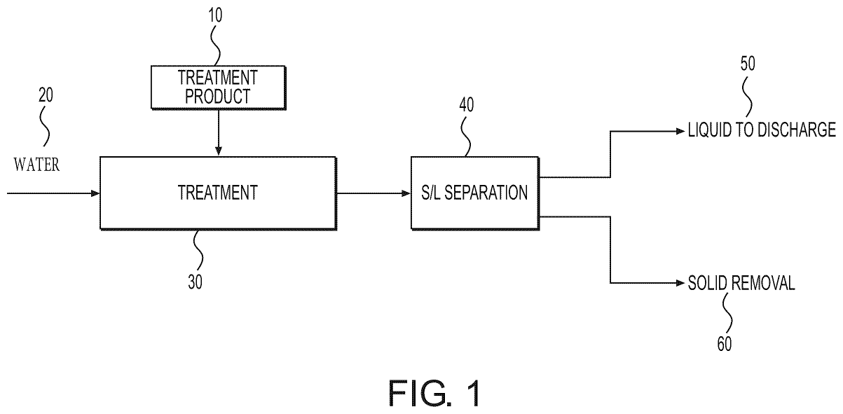

FIG. 1 depicts an embodiment of a single stage reaction process using a chemical treatment product 10 to remove sulfate from water 20. In FIG. 1, the treatment product 10 and water 20 are combined at a treatment step 30. The treatment step 30 may last for a predetermined amount of time, reacting the precipitants in the treatment product 10 with sulfate in the water 20 and forming precipitates. The precipitates may be separated at a solid/liquid separation step 40. The liquid 50 may then be utilized, and the solids 60 may then be discarded or recovered.

In some embodiments, the treatment product may be administered in a single stage. In the single stage process, all sulfate precipitates, such as the barite, the ettringite, and the gypsum, may all be formed in a single batch or where the calcium, aluminum, and optionally barium are combined together in the water. Additional stages or treatments of the water to precipitate sulfate may not be necessary. The single stage process may take place in a single vessel. In the single stage process, the treatment product may be administered only once. For example, the calcium precipitant, aluminum precipitant, barium precipitant, and/or the pH adjusting agent may all be added simultaneously, during overlapping durations, or in immediate succession of one another. As mentioned previously, in embodiments, the precipitants can be added together as a single blended product.

The single stage process with a treatment of calcium precipitant and aluminum precipitant may take 15 minutes to 120 minutes, 20 minutes to 90 minutes, 30 minutes to 75 minutes, or 60 minutes.

The single stage process with a treatment including the barium precipitant, in addition to the calcium and the aluminum precipitant, may take 5 minutes to 35 minutes, 10 minutes to 25 minutes, 12 minutes to 20 minutes, or 15 minutes.

At these predetermined times, the single stage process for embodiments provided in this disclosure may reduce a concentration of sulfate in water by up to 50%, 60%, 70%, 80%, 90%, 95%, or 99%.

In some embodiments, the final concentration of sulfate in the water may be less than 1,000 ppm, less than 500 ppm, less than 100 ppm, less than 50 ppm, less than 10 ppm, or less than 5 ppm.

The administration of the treatment product, such as in the single stage process, may also incidentally remove nutrients and heavy metals including but not limited to silica, nitrate, iron, arsenic, and/or chloride from the water, for example by way of forming precipitates. In some embodiments, a single stage process may remove up to 60%, 70%, 80%, or 90% of at least one of silica, nitrate, iron, arsenic, and/or chloride from water after a predetermined time. The predetermined times may be equal to the single stage process times described herein for the single stage process with a treatment of the calcium precipitant and the aluminum precipitant or for the single stage process with a treatment including the barium precipitant, in addition to the calcium precipitant and the aluminum precipitant.

In some embodiments, a method for treating water may include measuring the sulfate concentration in the water and determining a molarity of sulfate in the water. A treatment amount of the treatment product may then be determined based on a molar ratio sulfate in the water. The treatment may then be added to the water, and a reaction may take place for a predetermined amount of time. Precipitate formed by the reaction may then be removed. In some embodiments, the process may be a continuous process or a batch process.

In a continuous process, the concentration of sulfate in the water may be re-measured after a predetermined amount of time. The treatment amount to be applied to the water may then be re-determined, and the re-determined treatment amount may be applied to the water. This process may repeat indefinitely for the duration of the treatment process. In a batch-wise process, the amount of sulfate can be measured on a batch-by-batch basis.

In some embodiments, the water containing sulfate may be treated in an automated process by way of a controller, such as a processor or CPU, which receives signals indicating the measured amount of sulfate, calculates the treatment dosage of the precipitants, and sends a signal to equipment that can administer the calculated treatment amounts.

### EXAMPLES

Examples 1-8 of treatment products were prepared in either a liquid blend or a solid blend. Four samples of each Example were prepared at varying doses.

To prepare the water solutions with sulfate, water was purified by reverse osmosis, and measured concentrations of sulfate were added to the water. Multiple solutions were prepared at sulfate concentrations of approximately 500 ppm, 1,000 ppm, 1,500 ppm, and 2,000 ppm sulfate. The samples of the Examples were then added to respective solutions.

After a one hour reaction time, an amount of sulfate removed from the water was determined. Residual aluminum and residual calcium from CaCO₃ hardness were also determined.

Tables 1-4 detail the constituents of each Example, the initial concentration of sulfate in each of the solutions to which the samples of each Example were applied, and the dosage of each sample applied to the respective solution. Tables 1-4 further describe the results after the one hour reaction time.

As shown in the tables, the liquid blend used in the Examples included CaClₕ as the calcium precipitant and AlCl₃ as the aluminum precipitant. In the liquid blends, the molar ratio of calcium to aluminum was approximately 2.85:1. The solid blend used in the Examples included Ca(OH)₂ as the calcium precipitant and NaAlO₂ as the aluminum precipitant. The solid blend was in a powder form. In the solid blends, the molar ratio of calcium to aluminum was approximately 4.44:1.

Each Example included at least four samples. In each sample, the amount of treatment product dosage was increased while the respective sulfate concentration in the water remained the same. Accordingly, the molar ratio of calcium in the treatment product to an initial concentration of sulfate in the water was increased with each sample. The removal of sulfate after the one hour reaction time was then compared for each sample.

TABLE 1

| | | | | From | From | | | Residual | | | |
|---|---|---|---|---|---|---|---|---|---|---|---|
| | | as neat | | Product | Product | | | | Ca from | | |
| | | product | Sulfate | Al from | Ca from | | Removed | | CaCO3 | Consumed | |
| Initial Concentration of | | Dosage, | remaining, | product, | product, | % sulfate | Sulfate, | Al, | hardness, | Al, | Ca, |
| Sulfate in Water: 1000 ppm | Sample # | ppm | ppm | ppm | ppm | removal | ppm | ppm | ppm | ppm | ppm |
| Example 1 - Liquid Blend | 0 | 0 | 1013 | 0 | 0 | 0.00% | 0 | 0.01 | 10 | 0 | 0 |
| Calcium Chloride and | 1.1 | 5000 | 918 | 350 | 1000 | 9.38% | 95 | 18 | 44.4 | 332 | 955.6 |
| Aluminum Chloride | 1.2 | 10000 | 760 | 700 | 2000 | 24.98% | 253 | 22 | 72.8 | 678 | 1927.2 |
| CaCl₂ + AlCl₃ | 1.3 | 15000 | 142 | 1050 | 3000 | 85.98% | 871 | 122 | 199.2 | | |
| | 1.4 | 20000 | 201 | 1400 | 4000 | 80.16% | 812 | 100 | 736 | 1300 | 3264 |
| Example 2 - Solid Blend | 0 | 0 | 1013 | 0 | 0 | 0.00% | 0 | 0.01 | 10 | 0 | 0 |
| (NaAlO₂ + Ca(OH)₂) | 2.1 | 5000 | 327 | 450 | 2000 | 67.72% | 686 | 0.41 | 408.8 | 449.59 | 1591.2 |
| | 2.2 | 10000 | 57 | 900 | 4000 | 94.37% | 956 | 0.82 | 225.2 | 899.18 | 3774.8 |
| | 2.3 | 15000 | 21 | 1350 | 6000 | 97.93% | 992 | 0.89 | 248 | 1349.11 | 5752 |
| | 2.4 | 20000 | 3.8 | 1800 | 8000 | 99.62% | 1009.2 | 2.8 | 186.8 | 1797.2 | 7813.2 |

TABLE 2

| | | | | | | | | Residual | | | |
|---|---|---|---|---|---|---|---|---|---|---|---|
| | | as neat | | From | From | | | | Ca from | | |
| | | product | Sulfate | Product | Product | | Removed | | CaCO3 | Consumed | |
| Initial Concentration of | | Dosage, | remaining, | Al, | Ca, | % sulfate | Sulfate, | Al, | hardness, | Al, | Ca, |
| Sulfate in Water: 500 ppm | Sample # | ppm | ppm | ppm | ppm | removal | ppm | ppm | ppm | ppm | ppm |
| Example 3 - Liquid Blend | 0 | 0 | 521 | 0 | 0 | 0.00% | 0 | 0.01 | 0.28 | 0 | 0 |
| CaCl₂ + AlCl₃ | 3.1 | 2000 | 373 | 140 | 400 | 28.41% | 148 | 23 | 37.6 | 117 | 362.4 |
| | 3.2 | 5000 | 352 | 350 | 1000 | 32.44% | 169 | 18 | 61.2 | 332 | 938.8 |
| | 3.3 | 10000 | 214 | 700 | 2000 | 58.93% | 307 | 19 | 81.2 | 681 | 1918.8 |
| | 3.4 | 15000 | 95 | 1050 | 3000 | 81.77% | 426 | 45 | 177.6 | 1005 | 2822.4 |
| Example 4 - Solid Blend | 0 | 0 | 521 | 0 | 0 | 0.00% | 0 | 0.01 | 0.28 | 0 | 0 |
| (NaAlO₂ + Ca(OH)₂) | 4.1 | 1000 | 358 | 90 | 400 | 31.29% | 163 | 33 | 60 | 57 | 340 |
| | 4.2 | 2000 | 204 | 180 | 800 | 60.84% | 317 | 1.6 | 171.2 | 178.4 | 628.8 |
| | 4.3 | 5000 | 57 | 450 | 2000 | 89.06% | 464 | 0.2 | 416.8 | 449.8 | 1583.2 |
| | 4.4 | 10000 | 3.1 | 900 | 4000 | 99.40% | 517.9 | 0.1 | 418.8 | 899.9 | 3581.2 |

TABLE 3

| | | | | | | | | Residual | | | |
|---|---|---|---|---|---|---|---|---|---|---|---|
| | | as neat | | From | From | | | | Ca from | | |
| | | product | Sulfate | Product | Product | | Removed | | CaCO3 | Consumed | |
| Initial Concentration of | | Dosage, | remaining, | Al, | Ca, | % sulfate | Sulfate, | Al, | hardness, | Al, | Ca, |
| Sulfate in Water: 1500 ppm | Sample # | ppm | ppm | ppm | ppm | removal | ppm | ppm | ppm | ppm | ppm |
| Example 5 - Liquid Blend | 0 | 0 | 1457 | 0 | 0 | 0.00% | 0 | 0.01 | 0.28 | 0 | 0 |
| CaCl₂ + AlCl₃ | 5.1 | 5000 | 1064 | 350 | 1000 | 26.97% | 393 | 62 | 41.2 | 288 | 958.8 |
| | 5.2 | 10000 | 674 | 700 | 2000 | 53.74% | 783 | 85 | 28 | 615 | 1972 |
| | 5.3 | 15000 | 201 | 1050 | 3000 | 86.20% | 1256 | 133 | 62 | 917 | 2938 |
| | 5.4 | 20000 | 207 | 1400 | 4000 | 85.79% | 1250 | 107 | 42.8 | 1293 | 3957.2 |
| Example 6 - Solid Blend | 0 | 0 | 1457 | 0 | 0 | 0.00% | 0 | 0.01 | 0.28 | 0 | 0 |
| (NaAlO₂ + Ca(OH)₂) | 6.1. | 5000 | 446 | 450 | 2000 | 69.39% | 1011 | 0.23 | 252 | 449.77 | 1748 |
| | 6.2 | 10000 | 83 | 900 | 4000 | 94.30% | 1374 | 0.46 | 144.8 | 899.54 | 3855.2 |
| | 6.3 | 15000 | 33 | 1350 | 6000 | 97.74% | 1424 | 0.97 | 127.6 | 1349.03 | 5872.4 |
| | 6.4 | 20000 | 32 | 1800 | 8000 | 97.80% | 1425 | 0.52 | 86.8 | 1799.48 | 7913.2 |

TABLE 4

| | | | | | | | | Residual | | | |
|---|---|---|---|---|---|---|---|---|---|---|---|
| | | as neat | | From | From | | | | Ca from | | |
| | | product | Sulfate | Product | Product | | Removed | | CaCO3 | Consumed | |
| Initial Concentration of | | Dosage, | remaining, | Al, | Ca, | % sulfate | Sulfate, | Al, | hardness, | Al, | Ca, |
| Sulfate in Water: 2000 ppm | Sample # | ppm | ppm | ppm | ppm | removal | ppm | ppm | ppm | ppm | ppm |
| Example 7 - Liquid Blend | 0 | 0 | 1826 | 0 | 0 | 0.00% | 0 | 0.01 | 0.28 | 0 | 0 |
| CaCl₂ + AlCl₃ | 7.1 | 5000 | 1642 | 350 | 1000 | 10.08% | 184 | 33 | 4.8 | 317 | 995.2 |
| | 7.2 | 10000 | 1208 | 700 | 2000 | 33.84% | 618 | 82 | 30.4 | 618 | 1969.6 |
| | 7.3 | 15000 | 737 | 1050 | 3000 | 59.64% | 1089 | 131 | 13.6 | 919 | 2986.4 |
| | 7.4 | 20000 | 631 | 1400 | 4000 | 65.44% | 1195 | 125 | 31.2 | 1275 | 3968.8 |
| Example 8 - Solid Blend | 0 | 0 | 1826 | 0 | 0 | 0.00% | 0 | 0.01 | 0.28 | 0 | 0 |
| (NaAlO₂ + Ca(OH)₂) | 8.1 | 5000 | 978 | 450 | 2000 | 46.44% | 848 | 0.21 | 367.6 | 449.79 | 1632.4 |
| | 8.2 | 10000 | 29 | 900 | 4000 | 98.41% | 1797 | 0.44 | 168.4 | 899.56 | 3831.6 |
| | 8.3 | 15000 | 23 | 1350 | 6000 | 98.74% | 1803 | 11 | 75.2 | 1339 | 5924.8 |
| | 8.4 | 20000 | 20 | 1800 | 8000 | 98.90% | 1806 | 0.59 | 109.2 | 1799.41 | 7890.8 |

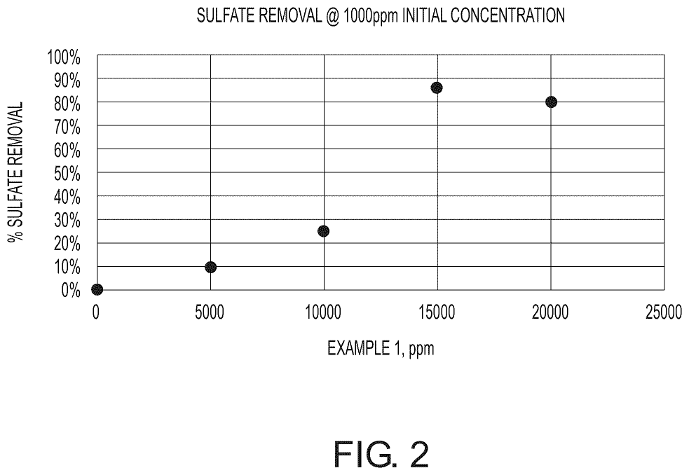

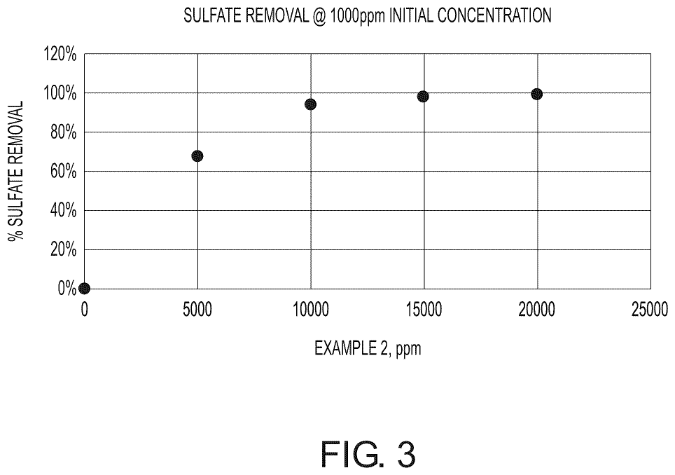

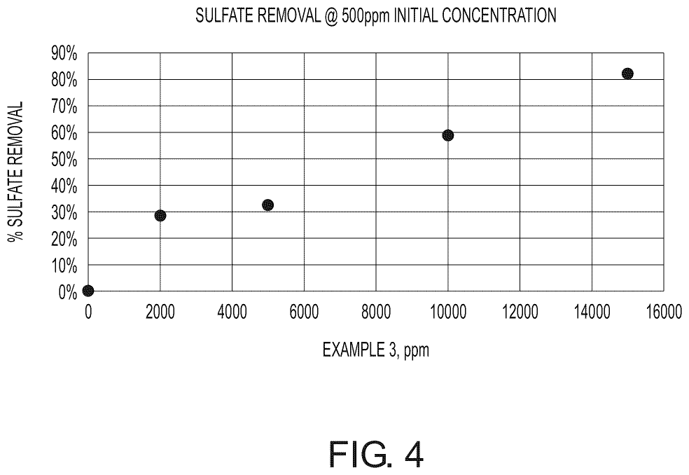

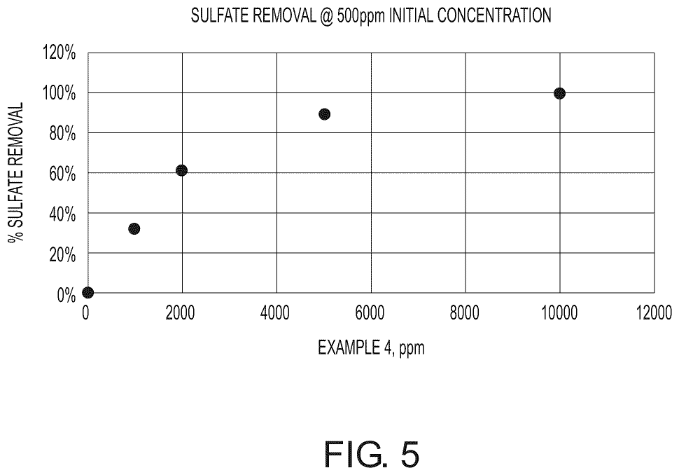

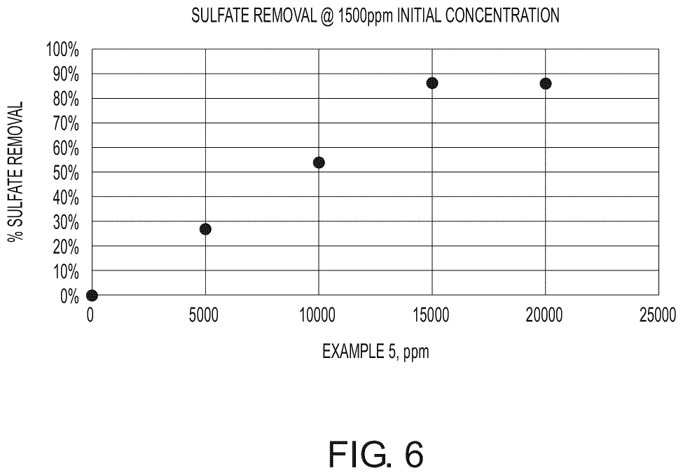

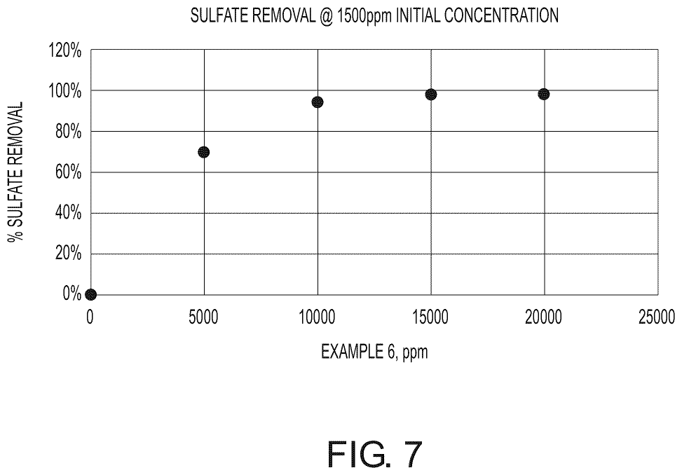

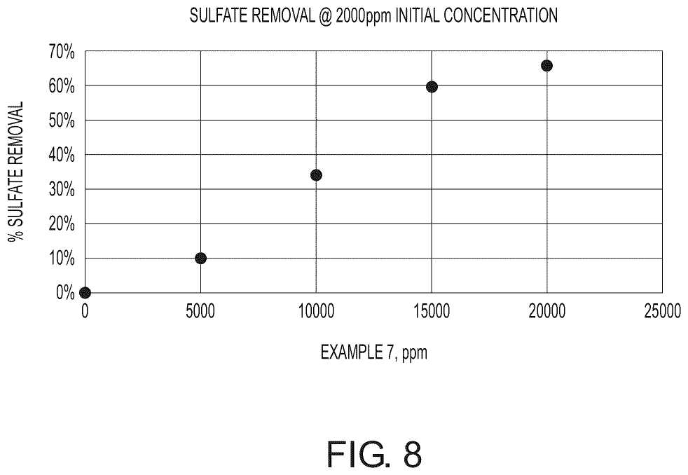

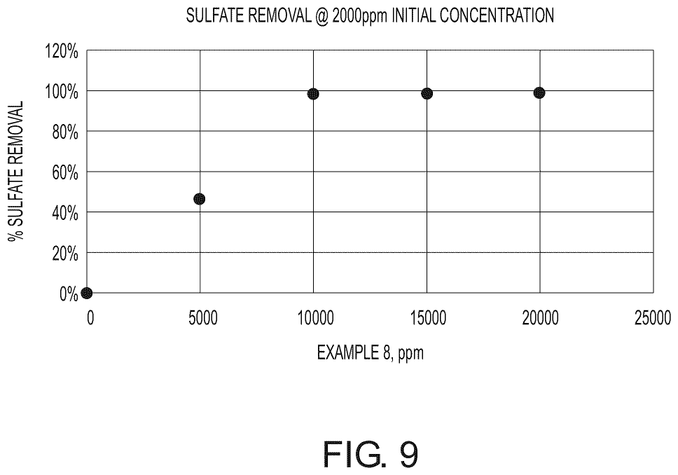

FIGS. 2-9 depict the sulfate removal in the solutions of Examples 1-8, respectively.

As shown in the tables and in FIGS. 2-9, an effective amount of sulfate was removed from the water for each of Examples 1-8.

For the liquid blends, a molar ratio of calcium in the treatment product to sulfate in the water as low as 1.33:1, 1.5:1, and 2:1 achieved sulfate removal in the water of over 50%, 59%, and 85%, respectively, as shown in Examples 1, 5, and 7.

In the solid blends, a molar ratio of calcium in the treatment product to sulfate in the water of as low as 2.66:1 and 2:1 achieved sulfate removal in the water of over 94% and over 98%, respectively, as shown in Examples 6 and 8.

As further shown in the Examples, a dosage of the solid blend typically achieved a greater sulfate removal than an equal dosage of that of the liquid blend. This is due to the water weight in the liquid blend. Given equal dosages of solid blend and liquid blend, the solid blend contains a greater amount of calcium and aluminum, resulting in higher molar ratios of calcium and aluminum in the treatment product to sulfate in the water.

It will be appreciated that the above-disclosed features and functions, or alternatives thereof, may be desirably combined into different methods and systems. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for treating water to remove sulfate from the water, wherein the sulfate is present in the water in an amount of at least 500 ppm, the method comprising:
combining a calcium precipitant and an aluminum precipitant together with the water;
reacting the calcium precipitant and the aluminum precipitant with the sulfate in the water to form sulfate precipitates; and
removing the sulfate precipitates from the water to provide purified water.

2. The method for treating water according to claim 1, wherein a molar ratio of calcium to aluminum combined together in the water is in a range of 1:1 to 12:1.

3. The method for treating water according to claim 2, wherein the molar ratio of calcium to aluminum combined together in the water is in a range of 3:1 to 5.5:1.

4. The method for treating water according to claim 1, wherein the calcium precipitant and the aluminum precipitant are provided together in a solid blend.

5. The method for treating water according to claim 1, wherein the calcium precipitant and the aluminum precipitant are provided together in a liquid blend.

6. The method for treating water according to claim 1, wherein the calcium precipitant and the aluminum precipitant are provided together in a slurry.

7. The method for treating water according to claim 1, wherein the precipitants have a solubility in water at 20° C. of at least 10 g/L.

8. The method for treating water according to claim 1, wherein the calcium precipitant comprises a non-lime precipitant.

9. The method for treating water according to claim 8, wherein the non-lime precipitant comprises calcium chloride.

10. The method for treating water according to claim 1, wherein the calcium precipitant and the aluminum precipitant are provided together with a pH adjusting agent.

11. The method for treating water according to claim 1, wherein the calcium precipitant and the aluminum precipitant are provided together with a barium precipitant.

12. The method for treating water according to claim 11, wherein a molar ratio of calcium to barium combined together in the water is in a range of 1:1 to 10:1.

13. The method for treating water according to claim 12, wherein the molar ratio of calcium to barium combined together in the water is in a range of 2:1 to 3:1.

14. The method for treating water according to claim 1, wherein a concentration of at least one of silica, nitrate, iron, arsenic, and chloride in the water is reduced by at least 60%.

15. The method for treating water according to claim 1, further comprising combining a cationic surfactant with the water.

16. The method for treating water according to claim 15, wherein the cationic surfactant is provided in a dosage in a range of 50 ppm to 1,500 ppm.

17. A single-stage reaction method for treating water containing sulfate, the method comprising:
combining a calcium precipitant and an aluminum precipitant together with the water in the same vessel;
reacting the precipitants with the sulfate in the water to form sulfate precipitates; and
separating the sulfate precipitates from the water to provide purified water that has an amount of sulfate that is less than 500 mg/l.

18. The single-stage reaction method of claim 17, wherein a molar ratio of calcium to the aluminum together in the water is in a range of 1:1 to 12:1.

19. The single-stage reaction method of claim 17, wherein a concentration of sulfate in the water is reduced by at least 50% when a predetermined amount of time of the reaction is 1 hour and an initial concentration of sulfate in the water is in a range of up to 2,000 ppm.

20. The single-stage reaction method of claim 17, further comprising combining a barium precipitant together with the calcium precipitant and the aluminum precipitant.

21. The single-stage reaction method of claim 20, wherein a concentration of sulfate in the water is reduced by at least 60% when a predetermined amount of time of the reaction is 30 minutes and an initial concentration of sulfate in the water is in a range of up to 5,000 ppm.

22. A combined treatment product that is effective to form precipitates with sulfate in water, the combined treatment product comprising a blend that includes:
a calcium precipitant; and
an aluminum precipitant;
wherein a molar ratio of calcium in the combined treatment product to aluminum in the combined treatment product is in a range of 1:1 to 12:1.

23. The combined treatment product of claim 22, wherein the blend further includes a barium precipitant, wherein a molar ratio of calcium in the combined treatment product to barium in the combined treatment product is in a range of 1:1 to 10:1.
